(19) United States
(12) Patent Application Publication
(10) Pub. No.: US 2026/0298128 A1
(43) Pub. Date: Oct. 1, 2026

(54) A COOLANT SYSTEM FOR A VEHICLE

(71) Applicant: VOLVO TRUCK CORPORATION, Göteborg (SE)

(72) Inventors: Nikhil N KULKARNI, Pune, Maharashtra (IN); Manoj Kumar S, Bangalore, Karnataka (IN)

(73) Assignee: VOLVO TRUCK CORPORATION, Göteborg (SE)

(21) Appl. No.: 19/489,776

(22) PCT Filed: Jun. 5, 2023
(86) PCT No.: PCT/IB2023/055781

§ 371 Date: Dec. 3, 2025

(51) Int. Cl. F01P 3/20; B60H 1/00; F01P 11/02; F01P 11/14

(52) U.S. Cl. CPC F01P 3/20; B60H 1/00278; F01P 11/0285; F01P 11/14; F01P 2050/24

(57) ABSTRACT

A coolant system for a vehicle, and a device and method for a coolant circuit of a vehicle thereof. The coolant system may comprise a coolant circuit, a pump configured for circulating a coolant in the coolant circuit, a heat exchanger connected to the coolant circuit and configured for exchanging heat between the coolant circulating through the heat exchanger and a vehicle component, a sensor connected to the coolant circuit and configured for sensing gas in the coolant circuit, an electronic control unit (ECU) communicatively connected to the sensor and configured for receiving data relating to the sensed gas from the sensor, and a valve integrated with a connector of the coolant circuit and configured for discharging the gas in the coolant circuit.

### TECHNICAL FIELD

The disclosure relates generally to a coolant system. In particular aspects, the disclosure relates to a coolant system for a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

A coolant system of a vehicle is the basis for ensuring the normal operation of the vehicle. However, with the popularity of electric and hybrid vehicles, the complexity of the coolant system has also increased. Accordingly, it's desirable to explore an effective and preferably active coolant system for a vehicle.

### SUMMARY

According to a first aspect of the disclosure, a coolant system for a vehicle. The coolant system comprises a coolant circuit, a pump, a heat exchanger, a sensor, an electronic control unit (ECU), and a valve. The pump may be configured for circulating a coolant in the coolant circuit. The heat exchanger may be connected to the coolant circuit and configured for exchanging heat between the coolant circulating through the heat exchanger and a vehicle component. The sensor may be connected to the coolant circuit and configured for sensing gas in the coolant circuit. The electronic control unit (ECU) may be communicatively connected to the sensor and configured for receiving data relating to the sensed gas from the sensor. The valve may be integrated with a connector of the coolant circuit and configured for discharging the gas in the coolant circuit. The first aspect of the disclosure may seek to propose an active coolant system for a vehicle. A technical benefit may include actively sensing, and accordingly discharging, the gas from the coolant circuit of the vehicle, which may help in degradation of the coolant system. This active discharging may be carried out at any appropriate time.

In some examples, including in at least one preferred example, optionally the valve is in communicative connection with the ECU or the sensor to receive an instruction to open for discharging the gas in the coolant circuit.

In some examples, including in at least one preferred example, optionally the ECU is configured for receiving an amount of the gas sensed by the sensor, determining whether the amount of the gas exceeds a predetermined threshold and sending the instruction to the valve in response to the amount of gas exceeding the predetermined threshold. A technical benefit may include setting a predetermined threshold for the vehicle. The threshold may be determined by taking into account a plurality of characteristics of the vehicle.

In some examples, including in at least one preferred example, optionally the sensor or the ECU is further configured for transmitting data relating to the sensed gas, or an amount of the gas, or both to a cloud storage. A technical benefit may include a predictable maintenance schedule for the vehicle and minimizing break downs.

In some examples, including in at least one preferred example, optionally the ECU is configured to send an alert to a driver dashboard of the vehicle in response to the amount of gas exceeding the predetermined threshold.

In some examples, including in at least one preferred example, optionally the vehicle component is an engine or battery, or both.

In some examples, including in at least one preferred example, optionally the valve is a vent valve, a float valve, a duck bill valve, an electrically actuated valve, an oleophobic valve, or a hygroscopic disc valve, etc.

In some examples, including in at least one preferred example, optionally the vehicle is an electric or hybrid vehicle.

According to a second aspect of the disclosure, a device for a coolant circuit of a vehicle. The coolant circuit includes a quick connector and the device comprises a sensor and a valve. The sensor may be arranged in the coolant circuit of the vehicle to sense gas in the coolant circuit, and communicatively connected to an electronic control unit (ECU) of the vehicle to send data relating to the sensed gas to the ECU. The valve may be arranged in the coolant circuit and coupled to the quick connector of the coolant circuit to discharge the gas in the coolant circuit. The second aspect of the disclosure may propose a device which may be easily integrated into a coolant system. A technical benefit may include providing an active coolant system for the vehicle.

In some examples, including in at least one preferred example, optionally the valve is in communicative connection with the ECU or the sensor to receive an instruction to open for discharging the gas from the coolant circuit.

In some examples, including in at least one preferred example, optionally the valve receives the instruction sent from the ECU in response to a determination by the ECU that an amount of the gas exceeds a predetermined threshold based on an amount of gas sensed by the sensor.

In some examples, including in at least one preferred example, optionally the sensor or the ECU transmits data relating to the sensed gas, or an amount of the gas, or both to a cloud storage.

In some examples, including in at least one preferred example, optionally the valve is a vent valve, a float valve, a duck bill valve, an electrically actuated valve, an oleophobic valve, or a hygroscopic disc valve, etc.

In some examples, including in at least one preferred example, optionally the vehicle is an electric or hybrid vehicle.

According to a third aspect of the disclosure, a method for a coolant circuit of a vehicle is provided, the coolant circuit comprising a sensor communicatively connected to an electronic control unit (ECU) of the vehicle, a quick connector, and a valve coupled to the quick connector. The method comprises sensing, with the sensor, gas in the coolant circuit; sending, with the sensor, data relating to the sensed gas to an electronic control unit (ECU) of the vehicle via a communicatively connection between the sensor and the ECU; receiving, with the ECU, the data relating to the sensed gas from the sensor; and discharging, with the valve, the gas in the coolant circuit. The third aspect of the disclosure may provide a method for a coolant circuit of a vehicle. A technical benefit may include the coolant circuit of the vehicle actively senses gas and discharges the sensed gas from the coolant circuit.

In some examples, including in at least one preferred example, optionally discharging the gas in the coolant circuit further comprising receiving, with the valve via a communicative connection with the ECU or the sensor, an instruction to open for discharging the gas.

In some examples, including in at least one preferred example, optionally the method further comprising receiving, with the ECU, an amount of the gas sensed by the sensor; determining, with the ECU, whether the amount of gas exceeds a predetermined threshold; and sending, with the ECU, the instruction to the valve in response to the amount of gas exceeding a predetermined threshold.

In some examples, including in at least one preferred example, optionally the method further comprising transmitting, with the ECU, an alert to a driver dashboard of the vehicle in response to the amount of gas exceeding the predetermined threshold.

In some examples, including in at least one preferred example, optionally the method further comprising transmitting, with the ECU or the sensor, the data relating to the sensed gas, or an amount of the gas, or both, to a cloud storage.

In some examples, including in at least one preferred example, optionally the valve is a vent valve, a float valve, a duck bill valve, an electrically actuated valve, an oleophobic valve, or a hygroscopic disc valve, etc..

The disclosed aspects, examples (including any preferred examples), and/or accompanying claims may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary diagram of system according to an example in which a vehicle is in communicative connection with a service center.

FIG. 2 is an exemplary coolant system of a vehicle according to an example of the disclosure.

FIG. 3 is an exemplary integration of a sensor and a valve into a coolant circuit of a vehicle according to an example of the disclosure.

FIG. 4 is another exemplary diagram of system according to an example of the disclosure in which a vehicle has an active coolant system.

FIG. 5 is an exemplary device for a coolant circuit of a vehicle according to an example of the disclosure.

FIG. 6 is a flow chart of an exemplary method for a coolant circuit of a vehicle according to an example of the disclosure.

FIG. 7 is a schematic diagram of an exemplary computer system for implementing examples disclosed herein, in relation to a coolant system of a vehicle according to an example of the disclosure.

### DETAILED DESCRIPTION

The detailed description set forth below provides information and examples of the disclosed technology with sufficient detail to enable those skilled in the art to practice the disclosure.

Existing coolant systems work in a passive manner In such passive systems, tests or inspections for a vehicle are performed when the vehicle is taken in for service. Therefore, such passive systems may fail to detect in advance any problems, such as gas in the coolant system, which may cause a coolant leak. When a coolant leak occurs, the coolant may overflow or shoot out from an expansion tank, along with air bubbles. There may also be a cavitation and coolant loss. In case that there are air bubbles in a CAB loop heater, the heater may be running dry, and overheat and break down. Also, with air bubbles present in a coolant circuit, there may be insufficient component cooling (e.g., heater, engine, engine gasket, battery, etc.) by the coolant system. Therefore, those components may degrade.

Examples of this disclosure propose a system to actively address the issue of gas in the coolant system. Such active solutions may help in predicting maintenance issues well in advance of problems manifesting. According to an example of this disclosure, a coolant system for a vehicle includes a coolant circuit. A sensor is connected to the coolant circuit for sensing gas in the coolant circuit. A valve is integrated with a connector of the coolant circuit for discharging the gas in the coolant circuit. The integrated valve may act as a deaeration valve and actively removes or deaerates the gas from the coolant circuit/loop. In this manner, the coolant system may provide a vehicle component (e.g., engines and battery) with an active deaeration loop. Such an active system may increase the life of vehicle components, preventing break downs, and minimizing maintenance costs.

Exemplary benefits brought by the examples illustrated herein may include, but are not limited to, facilitating or helping in deration of the coolant system, preventing or at least alleviating corrosion and degradation of the coolant system.

Details of exemplary systems and methods to achieve the aforementioned advantages and benefits are described herein. However, alternatives to the structure, layout, arrangement, etc., are contemplated without departing from the goals and scopes of the examples and aspects of the present disclosure.

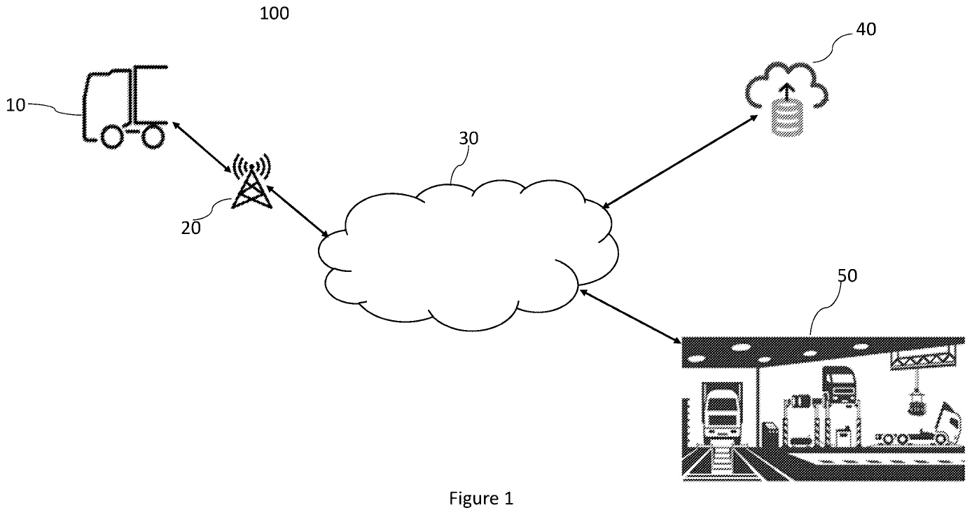

FIG. 1 is an exemplary diagram of system according to an example in which a vehicle is in communicative connection with a service center. In FIG. 1, a system 100 is shown. In the system 100, a vehicle 10 may access a network 30 via a wireless transmitter/receiver 20. The vehicle 10 may be a conventional vehicle, an electric vehicle, or a hybrid vehicle. The vehicle 10 may communicate, via network 30, with cloud storage 40 and service center 50. The cloud storage 40 and service center 50 may each have a respective communicative connection with network 30, via a wireless or wired connection. Vehicle 10 may upload data to the cloud storage 40 and service center 50. The data may relate to, for example, information about a running status of various components of the vehicle 10, such as an engine, vehicle battery, tire, etc. The service center 50 may perform real-time periodic diagnostics on the vehicle 10, and provide recommendations of maintenance and/or a repair plan. The cloud storage 40 may store data uploaded from the vehicle 10 and/or the service center 50, such as the running status, the diagnostics, the maintenance or repair plan.

The vehicle 10 and the service center 50 may access the data stored in the cloud storage 40 as needed. For example, when the driver of the vehicle 10 wants to retrieve diagnostic information, or when the service center 50 wants to get historical running status data of the vehicle 10.

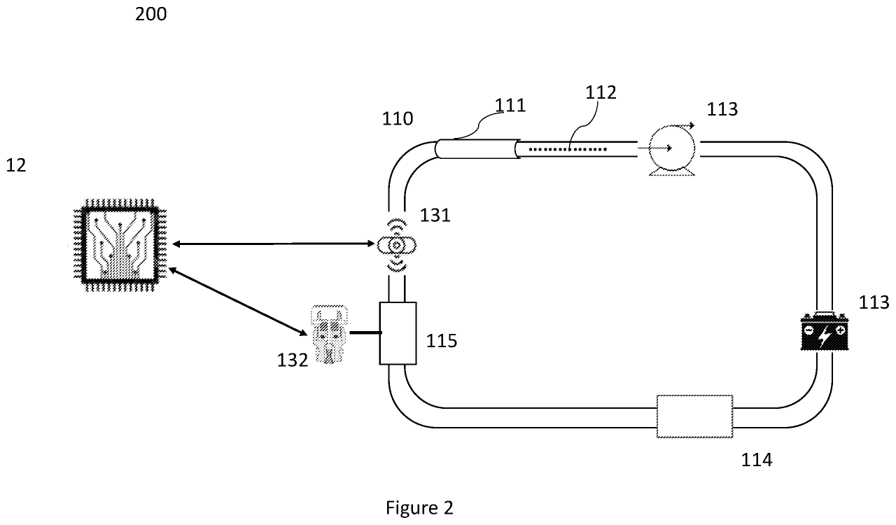

FIG. 2 is an exemplary coolant system of a vehicle according to an example of the disclosure. In FIG. 2, a coolant system 200 for a vehicle, for example vehicle 10, is shown. The coolant system 200 may comprise a coolant circuit 110 (may also be referred to as coolant loop). The coolant circuit 110 may include, for example, a coolant pipe or hose 111. A pump 113 may circulate a coolant 112 in the coolant circuit 110. A vehicle battery 113 may be arranged in the coolant circuit 110. The vehicle battery 113 may include batteries for an electric or hybrid vehicle. The battery 113 is an example of a vehicle component that may be cooled via the coolant system 200. The coolant system 200 may also be configured to cool down other vehicle components, such as an engine or any other vehicle component.

A heat exchanger 114 may be arranged in or connected to the coolant circuit 110 to exchange heat between the coolant 112 and vehicle battery 113. The coolant 112 may circulate through the heat exchanger 114. A sensor 131 may be arranged in or connected to the coolant circuit 110 to sense gas in the coolant circuit 110. In an example, the sensor 131 may be arranged at a location of the coolant circuit 110 where gas is more likely to present. In another example, more than one sensor 131 may be arranged along the coolant circuit 110.

The sensor 131 may be, for example, an air detection sensor. Sensor 131 may detect the presence of gas or air bubbles in the coolant circuit 110, or gas passing through coolant circuit 110. The gas detected by the sensor 131 herein may be air, gas, or vapor, which terms may be used interchangeably herein. Gas or air may be present in the coolant circuit 110 due to overheating, for example.

The sensor 131 may have a wireless or wired communicative connection to an electronic control unit (ECU) 12 of vehicle 10. The sensor 131 may send data it collects to ECU 12 via the communicative connection. The data may relate to the presence of gas in the coolant circuit 110. For example, the data may indicate a location where gas is present in the coolant circuit 110, an amount of gas, or any other relevant information. Not all the data collected by the sensor 131 may affect the operation of the valve 132, which will discussed in the following. But the data collected by the sensor 131 may still be useful. For example, data indicating where the gas is located in the coolant circuit 110 may be helpful when the service center 50 performs a remote diagnostic on the vehicle 10. The ECU 12 may receive the data from the sensor 131, via the communicative connection

The coolant circuit 110 may further include a connector 115, via which various components may be connected to the coolant circuit 110. A valve 132 may be coupled to or integrated with the connector 115. The valve 132 may be a deaeration valve, which is connected to or arranged in the coolant circuit 110 by the connector 115. As an example, valve 132 may be an automatic air vent valve. The valve 132 may discharge or deaerate gas from the coolant circuit 110 (e.g., when or in response to the sensor 131 detecting gas in the coolant circuit 110). In an example, the valve 132 may be in communicative connection with the ECU 12 to receive an instruction to open for discharging the gas in the coolant circuit 110. In another example, the valve 132 may be in communicative connection with the sensor 131 to receive an instruction from the sensor 131 to open for discharging the gas in the coolant circuit 110. In other words, the valve 132 may be controlled to open and close by the ECU 12 and/or the sensor 131. In other examples, the valve 132 may automatically vent the gas.

In an example, the ECU 12 may receive data from the sensor 131 relating to the sensed gas (e.g., an amount of the gas sensed by the sensor 131). The ECU 12 may determine whether the amount of sensed gas exceeds a predetermined threshold. Such predetermined threshold may be determined based on relevant historical statistical data and may be stored in the ECU 12 or in another memory. Other appropriate factors may also be considered as needed when setting a value of the threshold, such as the season, the environmental temperature, vehicle characteristics, age of the vehicle component, etc. The ECU 12 may send an instruction to the valve 132, in response to the amount of gas exceeding the predetermined threshold. The valve 132 may in turn deaerate the coolant circuit 110.

In an example, the ECU 12 may keep a record of the data received from the sensor 131. For example, the ECU 12 may note the time that gas was detected by the sensor 131, if the amount of gas detected has increased or decreased over time, if any of the sensor(s) 131 stopped sensing gas at a point in time, etc. In an example, the ECU 12 may also be calibrated based on the received data properly.

In particular, the ECU 12 may perform a calibration based on the data. During the calibration, new data may be considered as abnormal or uncommon detected results if the data deviates from prior data, for example if the new data falls outside of a range. The range may be a statistical range calculated based on historical data obtained in relation to vehicle 10, or in relation to a plurality of vehicles 10 of the same model. Data filling outside of the range may be discarded by the ECU 12. In this case, the ECU 12 may decide to wait for the next data from the sensor 131, and delay sending an instruction for discharging gas by the valve 132. Similarly, the ECU 12 may also keep records, i.e., calibrated data, in relation to the calibration process. Therefore, the calibrated data may help to more accurately measure the presence of gas in the coolant loop 110. In another example, the sensor 131 may have an ability to carry out actions described above as being performed by the ECU 12. In this case, the valve 132 may be controlled to open and close by the sensor 131 rather than by the ECU 12 (e.g., in response to the amount of gas exceeding the predetermined threshold).

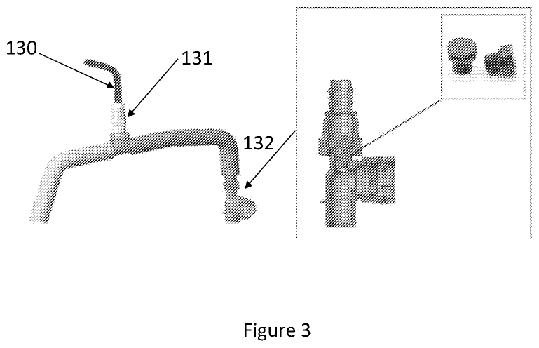

FIG. 3 is an example of a sensor and a valve arranged in a coolant circuit of a vehicle according to an example of the disclosure. FIG. 3 illustrates a portion of the coolant circuit 110. The sensor 131 may be integrated into the coolant line along the coolant circuit 110. The sensor 131 may communicate with the ECU 12 via a wiring harness 130. The valve 132 may be integrated with the connector 115 which is a part of the coolant circuit 110, by a quick coupling and thereby be arranged in line in the coolant circuit 110. The valve 132 may be an automatic deaeration valve integrated with the quick connector 115. Specifically, the valve 132 may be a vent valve, a float valve, a duck bill valve, an electrically actuated valve, an oleophobic valve, or a hygroscopic disc valve.

As shown in in FIG. 3, the connector 115 may have a profile compatible to be coupled with the valve 132. This compatible profile may help in ease of assembly during vehicle level packaging. In some examples of this disclosure, the connector 115 may be a quick connector. In some examples, the connector 115 may have a turn or bend. The turn or bend may make it more likely for gas to present or accumulate there. Therefore, integrating the valve 132 with the connector 115 may shorten the path for discharging the detected gas from the coolant circuit 110. Also, arranging the sensor 131 near the valve 132 (and therefore near the connector 115 also) may allow for a more accurate detection of gas in the coolant circuit 110.

The valve 132 illustrated in FIG. 3 is a vent valve equipped with an oleophobic membrane. The oleophobic membrane may allow venting of gas in the coolant circuit 110. The venting may involve a discharge, a passage, or a transport of air, gas, or vapor out of the vent valve 132, through a porous hydrophobic and/or oleophobic medium. This may, for example, purge the air out of in the coolant system 200.

In an example, the valve 132 in FIG. 3 may be the automatic air vent valve illustrated in FIG. 2. Such automatic air vent valve may include a hygroscopic disc. The hygroscopic disc may dry out resulting in compression of the hygroscopic disc, thereby providing a path for the gas in the coolant circuit 110 to escape through a port and then through a vent line.

In a further example, the valve 132 may be a float valve (e.g., a miniaturized float valve). In this scenario, gas may be collected in a vent causing the float to drop and open the valve. The water pressure inside the valve 132 may push the gas out. Then the float may rise and close the valve. An air cushion in the upper part of each vent may protect the valve 132 seat against contamination. In this way, the accumulated gas is released.

In another further example, a duck bill valve may be used as the valve 132. The duck bill valve is a unique, one-piece, elastomeric component that may act as backflow prevention device or one-way valve or check valve. The duck bill valve has elastomeric lips in the shape of a duckbill which may prevent a backflow (e.g., a backflow of the gas and coolant liquid) and allow forward flow. This may help in deaerating and avoiding backflow of the gas into the coolant system 200 and deaerating the gas through an expansion tank. In further additional examples, any other appropriate valves may be used as the valve 132.

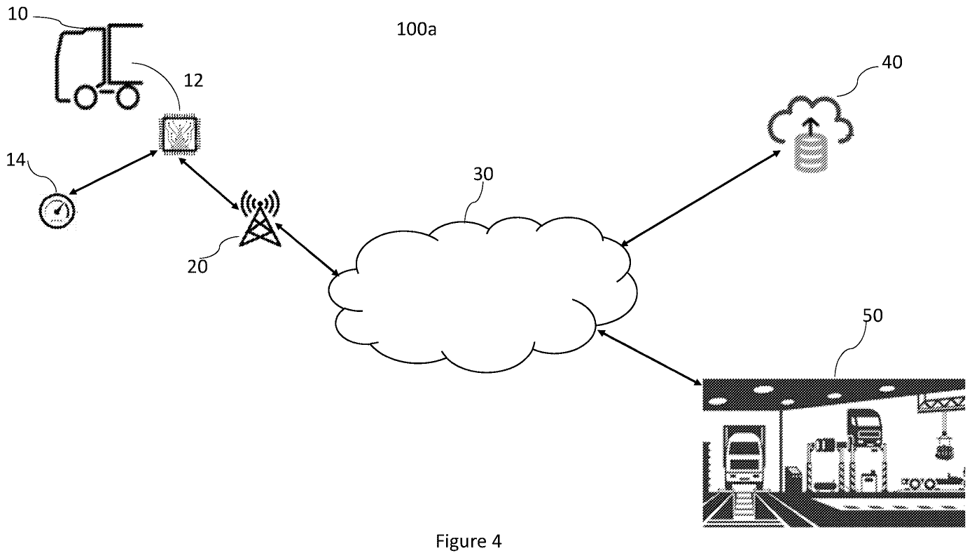

FIG. 4 is another exemplary diagram of system according to an example. With reference to FIG. 1, a similar system 100a is illustrated in FIG. 4. In system 100a, vehicle 10 may access the network 30 via the wireless transmitter/receiver 20 with its ECU 12. In system 100a, the ECU 12 may transmit or upload data to the cloud storage 40. The data may relate to the gas sensed by the sensor 131 of vehicle 10. For example, the data may include or indicate such as where the gas is present in the coolant circuit 110, an amount of gas, a determination by ECU 12 whether the amount of the gas exceeds the predetermined threshold, the value of the threshold, the calibrated data by the ECU 12, or any other information relating to the data collected by the sensor 131, or any combination thereof. In another example, the sensor 131 may send such data to the cloud storage 40, or additionally send similar data to the cloud storage 40. Then the data may be stored by the cloud storage 40. The stored data may be used for further calibration or other future use (e.g., by the service center 50). For example, such data maintained by the cloud storage 40 may be accessed later via a cloud-based service. Analysis of the data (e.g., the calibrated data) from the cloud storage 40 may help in conducting predictive maintenance. For example, analyzing the data may help the service center 50 decrease vehicle downtime by reducing the inspection time required at the center. In particular, by obtaining data indicating an amount of gas detected in the coolant circuit 110, the time the gas was detected and the location where the gas was detected by the sensor 131, the service center 50 may determine an issue with the coolant circuit 110 or the components arranged therein. In addition, by retrieving the data of multiple vehicles of the same or similar model from the cloud storage 40, the service center may have better diagnostic, maintenance and/or repair plans for a specific vehicle. Therefore, the data collected by the active coolant system 200 may allow proactive solutions to solve potential issues in the cooling system 200.

In another example, the ECU 12 may send an alert to a driver of the vehicle 10 in response to the amount of gas exceeding the predetermined threshold, or detecting the gas presence, or both. The ECU 12 may indicate such an event to the driver by sending an alert signal to a dashboard 14. An indicator such as a light, gauge, etc. may then alert the driver to take the vehicle 10 for maintenance.

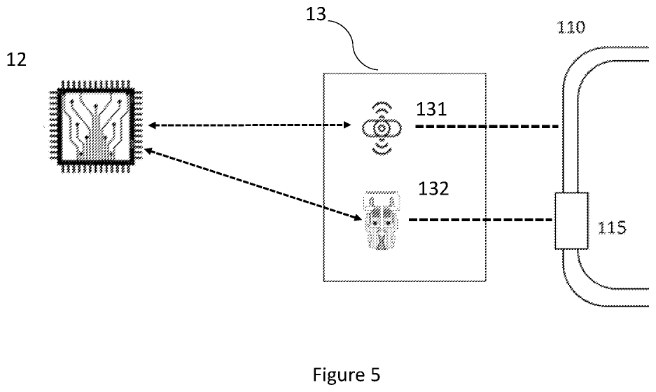

FIG. 5 shows an exemplary device 13 for a coolant circuit of a vehicle according to an example of the disclosure. The sensor 131 and valve 132 may be both integrated into the device 13. In addition, the device 13 may also include the quick connector 115. The device 13 illustrated in FIG. 5 may be integrated with the coolant circuit 110 and may cooperate with the ECU 12 as well. In FIG. 5, only a part of the coolant circuit 110 is shown. The device 13 may be coupled with the coolant circuit 110 of vehicle 10. The device 13 may comprise the sensor 131. Furthermore, the sensor 131 may be configured to communicatively connect to the ECU 12 of vehicle 10, to send data relating to the sensed gas to the ECU 12. The device 13 may further comprise a valve 132.

The coolant circuit 110 may comprise a quick connector 115. The valve 132 may be suitable for being coupled to or integrated with the quick connector 115 to discharge the gas in the coolant circuit 110. In an example, the valve 132 may be in communicative connection with the ECU 12 or the sensor 131, to receive an instruction to open for discharging the gas. In another example, the valve 132 may receive the instruction sent from the ECU 12 in response to a determination by the ECU 12 that an amount of the gas exceeds a predetermined threshold. The determination may be made based on the received amount of the gas sensed by the sensor 131.

In another example, the quick connector 115 may also integrate with or couple to the sensor 131. In other examples, the sensor 131 may be connected or coupled to any position of the coolant circuit 110. There may be no limitation on the relative positions of the sensor 131 and the valve 132, although the closer together the two are, the more effective deaeration of the coolant system 200 may be.

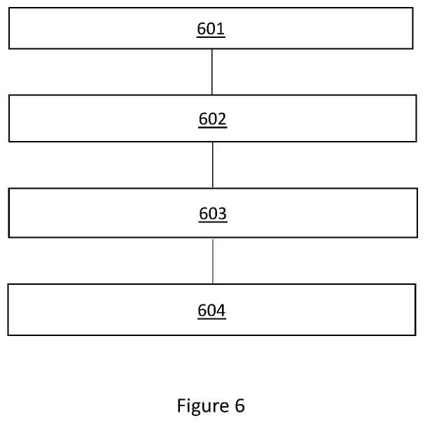

FIG. 6 is a flow chart of an exemplary method for removing gas from a coolant circuit of a vehicle according to an example of the disclosure. The coolant circuit may be the coolant circuit 110 illustrated in FIG. 2. The coolant circuit may also be the one illustrated in FIG. 5, where the coolant circuit 110 includes the sensor 131 communicatively connected to the ECU 12 of the vehicle 10. The coolant circuit 110 may further comprise the quick connector 115 and the valve 132 which may be coupled to the quick connector. The coolant circuit may also be other compatible coolant circuits to implement the method described herein. The method may comprise at step 601, sensing, with the sensor 131, gas in the coolant circuit 110. At step 602, the method may comprise sending, with the sensor 131, data relating to the sensed gas to the ECU 12 of the vehicle 10 via a communicative connection between the sensor 131 and the ECU 12. At step 603, the method may comprise receiving, with the ECU 12, the data relating to the sensed gas from the sensor 131. Then the method may comprise at step 604, discharging, with the valve 132, the gas in the coolant circuit 110.

In an example, for the step of discharging the gas in the coolant circuit 110, the method may further comprise receiving, at the valve 132 via a communicative connection with the ECU 12 or the sensor 131, an instruction to open for discharging the gas.

In another example, the method may further comprise receiving, with the ECU 12, an amount of the gas sensed by the sensor 131. The method may further comprise determining, with the ECU 12, whether the amount of gas exceeds a predetermined threshold. The method may further comprise sending, with the ECU 12, the instruction to the valve 132 in response to the amount of gas exceeding a predetermined threshold. In a further example, the method may further comprise transmitting, with the ECU 12, an alert to a dashboard 14 of the vehicle 10 in response to the amount of gas exceeding the predetermined threshold. In a further example, the method may further comprise transmitting, with the ECU 12 or the sensor 131, the data relating to the sensed gas, or an amount of the gas, or both, to a cloud storage 40. In a further example, the method may further comprise transmitting, with the ECU 12, calibrated data by the ECU 12 to the cloud storage 40. The calibrated data may be based on the data the ECU 12 received from the sensor 131.

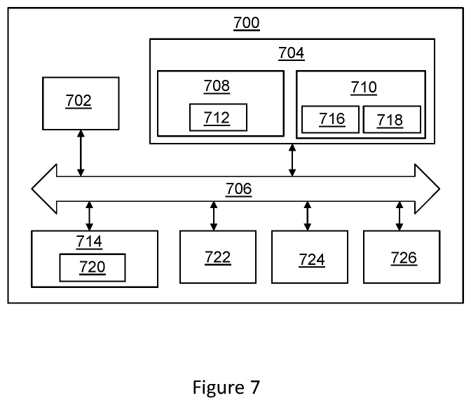

FIG. 7 is a schematic diagram of an exemplary computer system for implementing examples disclosed herein, in relation to a coolant system 200 of a vehicle 10 according to an example of the disclosure. In FIG. 7, is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN, an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The number of module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuit 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

### Example 1

A coolant system for a vehicle, the coolant system comprising: a coolant circuit; a pump configured for circulating a coolant in the coolant circuit; a heat exchanger connected to the coolant circuit and configured for exchanging heat between the coolant circulating through the heat exchanger and a vehicle component; a sensor connected to the coolant circuit and configured for sensing gas in the coolant circuit; an electronic control unit (ECU) communicatively connected to the sensor and configured for receiving data relating to the sensed gas from the sensor; and a valve integrated with a connector of the coolant circuit and configured for discharging the gas in the coolant circuit.

### Example 2

The coolant system of example 1, wherein the valve is in communicative connection with the ECU or the sensor to receive an instruction to open for discharging the gas in the coolant circuit.

### Example 3

The coolant system of example 2, wherein the ECU is configured for receiving an amount of the gas sensed by the sensor, determining whether the amount of gas exceeds a predetermined threshold and sending the instruction to the valve in response to the amount of gas exceeding the predetermined threshold.

### Example 4

The coolant system of example 1, wherein the sensor or the ECU is further configured for transmitting data relating to the sensed gas, or an amount of the gas, or both to a cloud storage.

### Example 5

The coolant system of example 3, wherein the ECU is configured for sending an alert to a driver dashboard of the vehicle in response to the amount of gas exceeding the predetermined threshold.

### Example 6

The coolant system of example 1, wherein the vehicle component is an engine or battery, or both.

### Example 7

The coolant system of example 1, wherein the valve is a vent valve, a float valve, a duck bill valve, an electrically actuated valve, an oleophobic valve, or a hygroscopic disc valve.

### Example 8

The coolant system of example 1, wherein the vehicle is an electric or hybrid vehicle.

### Example 9

A device for a coolant circuit of a vehicle, the coolant circuit including a quick connector and the device comprising: a sensor connected to the coolant circuit of the vehicle to sense gas in the coolant circuit, and communicatively connected to an electronic control unit (ECU) of the vehicle to send data relating to the sensed gas to the ECU; and a valve arranged in the coolant circuit and coupled to the quick connector of the coolant circuit to discharge the gas in the coolant circuit.

### Example 10

The device of example 9, wherein the valve is in communicative connection with the ECU or the sensor to receive an instruction to open for discharging the gas in the coolant circuit.

### Example 11

The device of example 10, wherein the valve receives the instruction sent from the ECU in response to a determination by the ECU that an amount of the gas exceeds a predetermined threshold based on received amount of the gas sensed by the sensor.

### Example 12

The device of example 9, wherein the sensor or the ECU transmits data relating to the sensed gas, or an amount of the gas, or both to a cloud storage.

### Example 13

The device of example 9, wherein the valve is a vent valve, a float valve, a duck bill valve, an electrically actuated valve, an oleophobic valve, or a hygroscopic disc valve.

### Example 14

The device of example 9, wherein the vehicle is an electric or hybrid vehicle.

### Example 15

A method for a coolant circuit of a vehicle, the coolant circuit comprising a sensor communicatively connected to an electronic control unit (ECU) of the vehicle, a quick connector, and a valve coupled to the quick connector, the method comprising: sensing, with the sensor, gas in the coolant circuit; sending, with the sensor, data relating to the sensed gas to an electronic control unit (ECU) of the vehicle via a communicatively connection between the sensor and the ECU; receiving, with the ECU, the data relating to the sensed gas from the sensor; discharging, with the valve, the gas in the coolant circuit.

### Example 16

The method of example 15, wherein discharging the gas in the coolant circuit further comprising: receiving, with the valve via a communicative connection with the ECU or the sensor, an instruction to open for discharging the gas.

### Example 17

The method of example 16, further comprising: receiving, with the ECU, an amount of the gas sensed by the sensor; and determining, with the ECU, whether the amount of gas exceeds a predetermined threshold; and sending, with the ECU, the instruction to the valve in response to the amount of gas exceeding a predetermined threshold.

### Example 18

The method of example 17, further comprising: transmitting, with the ECU, an alert to a driver dashboard of the vehicle in response to the amount of gas exceeding the predetermined threshold.

### Example 19

The method of example 15, further comprising: transmitting, with the ECU or the sensor, the data relating to the sensed gas, or an amount of the gas, or both, to a cloud storage.

### Example 20

The method of example 15, further comprising: transmitting, with the ECU, calibrated data by the ECU to a cloud storage.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element, or intervening elements may be present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A coolant system for a vehicle, the coolant system comprising:
a coolant circuit;
a pump configured for circulating a coolant in the coolant circuit;
a heat exchanger connected to the coolant circuit and configured for exchanging heat between the coolant circulating through the heat exchanger and a vehicle component;
a sensor connected to the coolant circuit and configured for sensing gas in the coolant circuit;
an electronic control unit (ECU) communicatively connected to the sensor and configured for receiving data relating to the sensed gas from the sensor; and
a valve integrated with a connector of the coolant circuit and configured for discharging the gas in the coolant circuit.

2. The coolant system of claim 1, wherein the valve is in communicative connection with the ECU or the sensor to receive an instruction to open for discharging the gas in the coolant circuit.

3. The coolant system of claim 2, wherein the ECU is configured for receiving an amount of the gas sensed by the sensor, determining whether the amount of gas exceeds a predetermined threshold and sending the instruction to the valve in response to the amount of gas exceeding the predetermined threshold.

4. The coolant system of claim 1, wherein the sensor or the ECU is further configured for transmitting data relating to the sensed gas, or an amount of the gas, or both to a cloud storage.

5. The coolant system of claim 3, wherein the ECU is configured for sending an alert to a driver dashboard of the vehicle in response to the amount of gas exceeding the predetermined threshold.

6. The coolant system of claim 1, wherein the vehicle component is an engine or battery, or both.

7. The coolant system of claim 1, wherein the valve is a vent valve, a float valve, a duck bill valve, an electrically actuated valve, an oleophobic valve, or a hygroscopic disc valve.

8. The coolant system of claim 1, wherein the vehicle is an electric or hybrid vehicle.

9. A device for a coolant circuit of a vehicle, the coolant circuit including a quick connector and the device comprising:
a sensor connected to the coolant circuit of the vehicle to sense gas in the coolant circuit, and communicatively connected to an electronic control unit (ECU) of the vehicle to send data relating to the sensed gas to the ECU; and
a valve arranged in the coolant circuit and coupled to the quick connector of the coolant circuit to discharge the gas in the coolant circuit.

10. The device of claim 9, wherein the valve is in communicative connection with the ECU or the sensor to receive an instruction to open for discharging the gas in the coolant circuit.

11. The device of claim 10, wherein the valve receives the instruction sent from the ECU in response to a determination by the ECU that an amount of the gas exceeds a predetermined threshold based on received amount of the gas sensed by the sensor.

12. The device of claim 9, wherein the sensor or the ECU transmits data relating to the sensed gas, or an amount of the gas, or both to a cloud storage.

13. The device of claim 9, wherein the valve is a vent valve, a float valve, a duck bill valve, an electrically actuated valve, an oleophobic valve, or a hygroscopic disc valve.

14. The device of claim 9, wherein the vehicle is an electric or hybrid vehicle.

15. A method for a coolant circuit of a vehicle, the coolant circuit comprising a sensor communicatively connected to an electronic control unit (ECU) of the vehicle, a quick connector, and a valve coupled to the quick connector, the method comprising:
sensing, with the sensor, gas in the coolant circuit;
sending, with the sensor, data relating to the sensed gas to an electronic control unit (ECU) of the vehicle via a communicatively connection between the sensor and the ECU;
receiving, with the ECU, the data relating to the sensed gas from the sensor;
discharging, with the valve, the gas in the coolant circuit.

16. The method of claim 15, wherein discharging the gas in the coolant circuit further comprising:
receiving, with the valve via a communicative connection with the ECU or the sensor, an instruction to open for discharging the gas.

17. The method of claim 16, further comprising:
receiving, with the ECU, an amount of the gas sensed by the sensor; and
determining, with the ECU, whether the amount of gas exceeds a predetermined threshold; and
sending, with the ECU, the instruction to the valve in response to the amount of gas exceeding a predetermined threshold.

18. The method of claim 17, further comprising:
transmitting, with the ECU, an alert to a driver dashboard of the vehicle in response to the amount of gas exceeding the predetermined threshold.

19. The method of claim 15, further comprising:
transmitting, with the ECU or the sensor, the data relating to the sensed gas, or an amount of the gas, or both, to a cloud storage.

20. The method of claim 15, further comprising:
transmitting, with the ECU, calibrated data by the ECU to a cloud storage.
